(19) United States
(12) Patent Application Publication
(10) Pub. No.: US 2010/0291948 A1
(43) Pub. Date: Nov. 18, 2010

(54) COMMUNICATION SYSTEM AND METHOD FOR AUTOMATICALLY SENDING MESSAGES BY PORTABLE COMMUNICATION DEVICE

(75) Inventors: YI-FANG WU, Tu-Cheng (TW); YE YUAN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/508,847

(22) Filed: Jul. 24, 2009

(30) Foreign Application Priority Data
May 18, 2009 (CN) 200910302400.7

(51) Int. Cl. H04W 64/00; G10L 13/08

(52) U.S. Cl. 455/456.1; 704/260; 704/E13.001

(57) ABSTRACT

A communication system includes a portable communication device. The portable communication device includes a receiver module, a GPS module, a message generating module, and a message sending module. The GPS module is capable of determining location information of the portable communication device and a remote receiver whose information stored in the receiver module. The message generating module is capable of automatically generating a message according to the remote receiver information, the message comprising the location information. The message sending module capable of automatically sends the message to the remote receiver. A method is further provided to automatically sending a message to a receiver from a portable communication device.

### BACKGROUND

1. Technical Field

The present disclosure relates to communication systems and methods for sending messages, and particularly to a communication system and a method capable of automatically sending a message to remote receivers by a portable communication device.

2. Description of Related Art

To contact others using short messages, many operations must be performed on a mobile telephone, such entering a message editing mode, entering a message, entering a sending mode, selecting one or more receivers, then sending. All of which is tedious and inconvenient, particularly if many short messages need to be sent in relatively short space of time.

### BRIEF DESCRIPTION OF THE DRAWINGS

Many aspects of the present disclosures can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a diagram of an embodiment of a portable communication device.

FIG. 2 is flow chart of a method using the portable communication device of FIG. 1.

### DETAILED DESCRIPTION

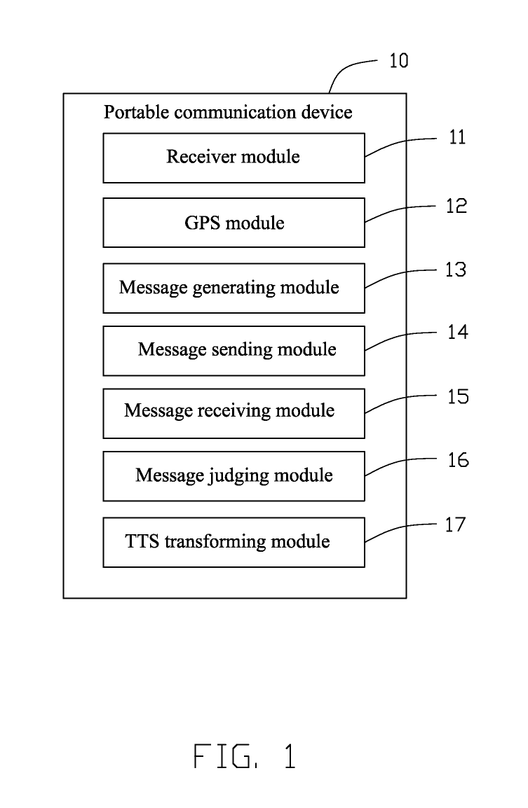

Referring to FIG. 1, an embodiment of a portable communication device 10, such as a portable telephone, includes a receiver module 11, a GPS (Global Position System) module 12, a message generating module 13, a message sending module 14, a message receiving module 15, a message judging module 16, and a TTS (Text to Speech) transforming module 17.

The receiver module 11 stores information of remote receivers. The remote receivers may be, for example, friends, family, colleagues of the user of the portable communication device, or points of interest, such as hotels, gas stations, and stores. The information of remote receivers is used for the user of the portable communication device 10 to conveniently contact the remote receivers, and may include names, phone numbers, and addresses, for example. The receiver module 11 is capable of being used to edit the information of the remote receivers, such as deleting, adding, or revising.

The GPS module 12 is capable of receiving current location information of the portable communication device 10 and location information of remote receivers, and possible routes that could be taken from current location of the portable communication device 10 to the location of a chosen remote receiver. The location information may include geographical coordinates and addresses, for example.

The message generating module 13 is capable of generating different text messages according to different remote receivers stored in the receiver module 11. The text messages may include the current location of the portable communication device 10, the velocity and direction of movement of the portable communication device 10, and an estimated time of arrival to the remote receiver's location, for example.

The message sending module 14 is capable of sending the text messages generated by the message generating module 13 to the corresponding remote receivers, being used to set rules for when and how often to send text messages to a same remote receiver, and determining a time period between two continuous text messages sent to the same remote receiver. For example, a rule could be established that a message is sent every time the distance between the locations of the portable communication device 10 and the remote receiver is reduced by one kilometer.

A message receiving module 15 is capable of receiving text messages sent to the portable communication device 10.

A message judging module 16 is capable of judging whether the text message received by the message receiving module 15 is sent by one of the remote receivers in the receiver module 11.

The TTS transforming module 17 is capable of transforming the text message received by the message receiving module 15 to an audio message.

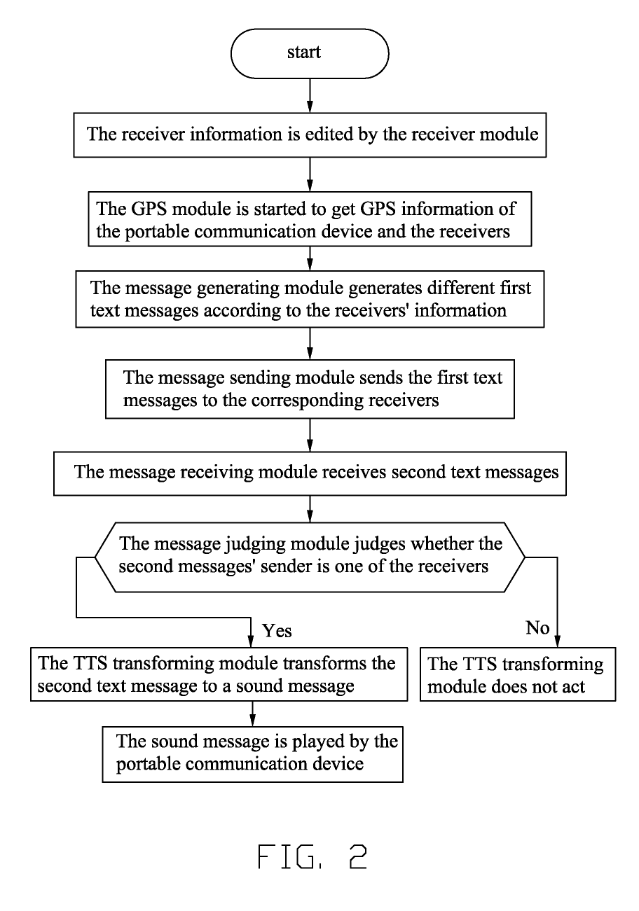

Referring also to FIG. 2, in use, the remote receiver information is edited by the receiver module 11 of the portable communication device 10. The GPS module 12 is started to get GPS information of the portable communication device 10 and the remote receivers. The message generating module 13 generates different first text messages according to the information of remote receivers stored in the receiver module 11, and the message sending module 13 sends the first text messages to the corresponding remote receivers. After the first text messages are sent out, if the message receiving module 15 receives a second text message sent from a sender, the message judging module 16 would judge whether the sender of the second text message is one of the remote receivers whose information is stored in the receiver module 11. If so, the TTS transforming module 17 transforms the second text message to an audio message, and plays the audio message by the portable communication device 10. If the sender is not one of the remote receivers, the TTS transforming module 17 does not act. According to the rules described above, after a time period determined by the message sending module 14, the message generating module 13 generates third different text messages according to the information of the remote receivers stored in the receiver module 11 again, and the message sending module 13 sends the third text messages to the corresponding remote receivers. Then the message judging module 16 and the TTS transforming module 17 perform as described above.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A communication system comprising:
a portable communication device comprising:
a receiver module;
a GPS module capable of determining location information of the portable communication device and a remote receiver whose information stored in the receiver module;
a message generating module capable of automatically generating a message according to the remote receiver information, the message comprising the location information; and
a message sending module capable of automatically sending the message to the remote receiver.

2. The communication system of claim 1, further comprising a message receiving module capable of receiving messages.

3. The communication system of claim 2, further comprising a message judging module capable of judging whether the received message is from the remote receiver.

4. The communication system of claim 3, the message is a text message.

5. The communication system of claim 4, further comprising a TTS transforming module capable of transforming the text message to a sound message when the received message is from the remote receiver.

6. The communication system of claim 1, wherein the remote receiver information comprises names, phone numbers, addresses, coordinates of geography or combinations thereof; the location information comprises a coordinate of geography, address, or combinations thereof.

7. The communication system of claim 1, wherein the message further comprises the moving velocity of the portable communication device, how much time from the current location to the remove receiver, salutation languages, or a combination thereof.

8. The communication system of claim 1, wherein the message sending module is capable of determining a time period between two text messages sent to the same remote receiver, according to a distance between the locations of the portable communication device and the remote receiver, and the relative moving velocity of the portable communication device and the remote receiver.

9. A method for automatically sending a message to a receiver from a portable communication device, comprising:
a GPS module determining location information of the portable communication device and the remote receiver whose information is stored in a receiver module;
a message generating module automatically generating a message according to the remote receiver information; and
a message sending module automatically sending the message to the remote receiver.

10. The method of claim 9 further comprising, after the message sending module sends the message to the remote receiver, a message receiving module of the portable communication device receiving a text message sent to the portable communication device.

11. The method of claim 10, further comprising, after the message receiving module receiving the text message, a message judging module judging whether the received message is from the remote receiver.

12. The method of claim 11, further comprising a TTS transforming module transforming the text message to a sound message when the text message is sent from the remote receiver.
